(19) United States
(12) Patent Application Publication
(10) Pub. No.: US 2011/0230699 A1
(43) Pub. Date: Sep. 22, 2011

(54) Method of Recycling Process for Garbage, Trash, Chemical Waste, and Energy

(76) Inventor: Nichelle REESE, Cincinnati, OH (US)

(21) Appl. No.: 12/882,393

(22) Filed: Sep. 15, 2010

Related U.S. Application Data
(60) Provisional application No. 61/316,275, filed on Mar. 22, 2010.
(60) Provisional application No. 61/332,448, filed on May 7, 2010.

(51) Int. Cl. B09B 3/00

(52) U.S. Cl. 588/252; 209/2; 209/233

(57) ABSTRACT

A method and process for recycling municipal and chemical wastes to obtain reusable materials or products for manufacturing of new goods. The present invention processes reusable chemicals for energy and reusable raw materials for manufacturing and reselling of products. Through the separation of municipal wastes, the user is able to further distinguish the distinct properties of the involved materials by its raw components and useful, potentially reusable chemical components. By the method of reprocessing raw materials, the present invention yields newly made products that are reusable and available for resale out of old scraps of chemical or municipal waste. Recycled products include and are not excluded to toys, kitchen appliances, military weaponry, missiles, fireworks, and vehicles.

The current application claims a priority to the U.S. Provisional Patent application Ser. Nos. 61/316,275 filed on Mar. 22, 2010 and Ser. No. 61/332,448 filed on May 7, 2010.

### FIELD OF THE INVENTION

The present invention generally relates to a method of recycling waste. More particularly, the present invention is a method to separate materials, decompose said materials into raw form, and reprocess said raw products into reusable energy and merchandise.

### BACKGROUND OF THE INVENTION

The amount of waste covering the world is immeasurable. Given rough figures, it is estimated that, at the world level, municipal and industrial waste amounts to 3.4 to 4 billion tons produced annually. It is safe to say that the world produces roughly 10 million tons of waste per day. Municipal waste refers to household, or domestic, waste. These include food and kitchen waste, paper, glass, bottles, cans, metals, plastics, construction and demolition waste, clothing, toys, household hazardous wastes i.e. medication, computers, paints, chemicals, light bulbs, fluorescent tubes, spray cans, fertilizers, pesticides, batteries, and the list goes on. And of the 3.4 to 4 billion tons of produced municipal and industrial waste, about 2.74 billion is what is collected and more accurately measured as trash.

Chemical waste is classified as either hazardous or non-hazardous waste. Chemical wastes are usually segregated on-site into appropriate waste containers and disposed by specialist contractors in order to meet safety, health, and legislative requirements. Numerous chemical and toxic wastes include animal waste, arsenic, asbestos, asphalt, chlorine, computer chip plants, DDT (also known as a synthetic pesticide), dioxin (a manufacturing byproduct from incinerating chlorine-containing substances; considered an environment pollutant; also toxic), dredge materials, e-wastes (electronics wastes), fertilizers, fiberglass, foods, incinerator ash, lead, medical waste, mercury, mining, MTBE (a gasoline additive), nuclear and radioactive waste, phthalates, plastics, and more. It is said that enough hazardous waste is generated in one year to fill the New Orleans Superdome 1,500 times over. A lot of these chemical wastes —hazardous or non-hazardous—are left alone mostly due to the high cost in collecting and disposing these hard-to-handle materials.

In response to both kinds of waste, the present invention serves to recycle much of these wasted materials—household or chemical—and to transform them into reusable products, merchandise, or usable forms of energy.

### BRIEF DESCRIPTION OF THE DRAWINGS

FIG. 1 is a process diagram of the present invention.

### DETAIL DESCRIPTIONS OF THE INVENTION

All illustrations of the drawings are for the purpose of describing selected versions of the present invention and are not intended to limit the scope of the present invention.

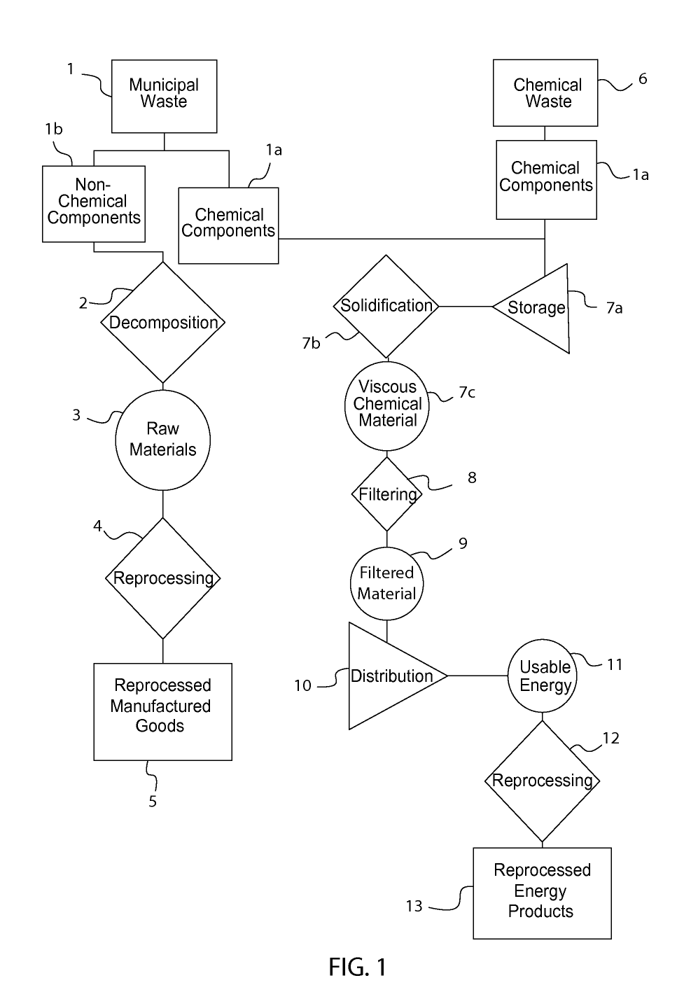

The present invention is a method of the recycling process for garbage, trash, and chemical waste. In FIG. 1, the diagram illustrates the two of the larger forms of trash, municipal waste 1 and chemical waste 6. The municipal waste 1 is defined by two parts: chemical components 1a and non-chemical components 1b. An example of chemical components 1a would be the lead, cadmium, beryllium, mercury, and brominated flame retardants contained within scrap CRT computer monitors. On the other hand, from this same scrap item the metal used to comprise the frame support and base of the monitor is an example of a non-chemical component 1b and can be later recycled into metal shelf support arms. By non-chemical, the item still comprises chemical compounds that makeup the part but is considered negligible within the pile of chemical waste 6. After the municipal waste 1 is separated and collected, the non-chemical components 1b are taken and broken down by decomposition means 2. The decomposition means 2 involve sorting, fusing, and processing the non-chemical components 1b. The raw materials 3 are transported to processing plants where welders melt down the metals, plastics, rubbers, and other various non-chemical components 1b. These are then delivered to companies who process and sort the raw materials 3. Sorting is done by workers at the plants while forklift drivers move the large amounts of packaged raw materials 3. The non-chemical components 1b, after being decomposed, then become pure raw materials 3. The raw materials 3 are obtained and then reprocessed by materials reprocessing means 4. During this step in the method of recycling garbage, the raw materials 3 are mixed, reshaped, and reformed into the likeness of the desired manufactured goods. Once the raw materials 3 are done being reprocessed, they become reprocessed manufactured goods 5. These reprocessed manufactured goods 5 can be include any goods such as but not limited to toys, car parts, and machinery. Even Dune Buggies with wheels and an outer shell casing can be produced. Using the present invention's materials reprocessing means 4 with the raw materials 3 of rubber and plastic, its tires and body kit can be manufactured. Housing structures including sidings of a house, a stove, and furniture can be made out of reprocessed plastic, metal, wood, and fabrics. A GPS navigation system can be made with recycled metals and plastics for its inner components. Numerous kitchen appliances can be remade into new appliances out of the same metals, plastics, and composite materials.

The municipal wastes' 1 other component, the chemical components 1a, join the chemical components 1a of the chemical waste 6. When the chemical components 1a of the municipal waste 1 and the chemical waste 6 are collected, they are then handled. Because of the abundance of garbage and backlogged chemical materials, proper storage is necessary in the method of the present invention to retain the necessary properties of the chemical components 1a for manufacturing. During the process of handling, the chemical components 1a are stored into barrels 7a. Once placed in the barrels 7a, they then go through a solidifying process in which dry ice cooling 7b occurs. Dry ice cooling 7b turns the chemical components 1a into a tar-like, chunky substance which is defined as viscous chemical material 7c. The viscous chemical material 7c is then obtained and put through the filtering process, as shown in the diagram of FIG. 1. In this process, filtering means 8 are used to filter the viscous chemical material 7c. The filtering means 8 have two embodiments: a coffee filter and a furnace filter. Either can be used as the filtering means 8 for the viscous chemical material 7c. The viscous chemical material 7c is then considered filtered material 9. The filtered material 9 is then distributed by distributing means 10 and then becomes usable energy 11. By energy reprocessing means 12, the usable energy 11 is finally obtained as reprocessed energy products 13. As seen on FIG. 1, one of the purposes of the present invention to create different forms of energy using chemical components 1a is fulfilled by the energy reprocessing means 12. The reprocessed energy products 13 can become many sources of usable energy 11 for various forms of high-costing performance-oriented tasks. For example, reprocessed energy products 13 can be used to fuel a rocket ship, fire missiles, and even fireworks. With the addition to Kool-Aid powder, the present invention can provide usable energy 11 to shoot colored fireworks into the sky for people's enjoyment. Other forms of energy that may fall under reprocessed energy products 13 include gas, kerosene, aviation fuel, and missile rocket fuel. Chemical wastes 6 such as uneaten leftover foods and animal excrements in the present invention are reprocessed into animal feed or fertilizers. The present invention not only provides a method of recreating usable forms of energy and manufactured products but also creates many job opportunities as well as save the earth from polluting byproducts from the current processes that manufacture the many forms of energy aforementioned. After the manufacturing of reprocessed goods, the reprocessed energy products 13 in order to be bought and sold require more workers, meaning more jobs for the unemployed.

Recyclable Materials

| Plastic | Cans | Cardboard/Wood |
|---|---|---|
| Television Frames | Box Springs | Table & Chairs |
| Computer Frames | Automobiles | Decks |
| Cups & Plates | Microwave | Doors |
| Car Interiors | Steel | Furniture |
| Copiers | Aluminum Foil | Picture Frames |
| Printers | CDs & DVDs | Money |
| Toys | Springs in Furniture | Books |
| Microwave Door | Steel Toe Boots | Dictionary |
| Speakers | Aluminum House | Bibles |
| Hearing Aids | Sidings | Encyclopedias |
| Eyes Glasses | Gutters | Telephone Poles |
| VCR Player | Pipe Drains | Cabinets |
| DVD Player | Entry Steel Doors | Desks |
| Plastic Bottles | Window Frames | |
| Vacuum Cleaners | Air Conditioning | |
| Radios | Units | |
| Box Fans | Central Air Systems | |
| Plastic Glass | Mufflers | |
| Automobiles | Exhaust Pipes | |
| Garbage Bags | Box Fans | |
| Sandwich Bags | Transmission | |
| VHS Tapes | Engines | |
| Garbage Cans | Door Knobs | |
| Camera | Pots & Pans | |
| Video Camera | Metal Detector Doors | |
| Cell Phone | Metal Detector | |
| | Machines | |
| | Silverware | |
| | Canned Goods | |
| | Metal Poles | |
| | Steel Toe Gym Shoes | |
| | Vinyl | |
| | Cell Phone | |
| | Stoves | |
| | Refrigerator | |
| | Ovens | |
| | Furnace | |
| | Hot Water Heaters | |

| Paper | Concrete | Rubber |
|---|---|---|
| Paper Towels | Bricks | Tires |
| Toilet Paper | Stones | Highway Cones |
| Books | Rocks | Water Hoses |
| Dictionary | Debris | Elastics |
| Bibles | | Rubber Bands |
| Encyclopedias | | Bulletproof |
| Tissue Paper | | Materials |
| Money | | Rubber Bullets |
| | | Leather Coats |
| | | Leather Jackets |
| | | Leather Pants |
| | | Leather Vests |
| | | Leather Shoes |
| | | Leather Chairs |
| | | Wheelchairs |
| | | Canes |
| | | Scooters |
| | | Toys |
| | | Carseats |
| | | Cushions |
| | | Golf Carts |
| | | Cars |
| | | School Supplies |
| | | Hospital |
| | | Materials |
| | | Workplace |
| | | Materials |
| | | School Materials |

As shown in TABLE 1, a few items are given as examples of possible recyclable materials. Some recyclable materials, as referenced in TABLE 1, include plastic, cans cardboard and wood, and paper. Once the reprocessing is completed, the reprocessed manufactured goods 5 are ready to be sold. A number of examples of reprocessed manufactured goods 5 that have been recycled from plastic bottles, for instance, include television frames, computer frames, cups and plates, car interiors, copiers & printers, toys, microwave doors, speakers, hearing aids, eye glasses, entertainment players, more plastic bottles, vacuum cleaners, and the list goes on. Using the present invention, recycling cans can yield new box springs, automobiles, microwaves, more raw steel, aluminum foil, compact discs, DVDs, furniture springs, steel toe boots, aluminum house sidings, gutters, pipe drains, entry steel doors, window frames, air conditioning units, car parts, etc. And cardboard/wood are potential materials for a new table & chairs, decks, doors, furniture, picture frames, money bills, books, dictionaries, bibles, encyclopedias, telephone poles, cabinets, and desks. While millions of pounds of paper are thrown away every year, much of that can be reprocessed and then reused as new paper towels, toilet paper, book leaves, and tissue paper. Many of these items are potentially remade items of the present invention. Each of the items also has their own manufacturers and their own marketplaces, translating into more jobs and more opportunities.

Although the invention has been explained in relation to its preferred embodiment, it is to be understood that many other possible modifications and variations can be made without departing from the spirit and scope of the invention as hereinafter claimed.

What is claimed is:

1. A method of recycling process for municipal wastes and chemical wastes comprises,
providing by municipal wastes and chemical wastes chemical components;
handling of chemical components;
filtering by filtering means viscous chemical material;
obtaining by the filtering means filtered material;
distributing by distributing means the filtered material;
obtaining by distributing means usable energy;
reprocessing by energy reprocessing means the usable energy; and
obtaining by energy reprocessing means reprocessed energy products.

2. The method as claimed in claim 1 comprises,
providing non-chemical components;
decomposing by decomposition means the non-chemical components;
obtaining by decomposition means raw materials;
reprocessing by materials reprocessing means raw materials; and
obtaining by materials reprocessing means reprocessed manufactured goods.

3. The method as claimed in claim 2, wherein decomposition, comprises,
sorting the non-chemical components;
fusing the non-chemical components; and
processing the non-chemical components.

4. The method as claimed in claim 1, wherein handling of chemical components, comprises,
storing chemical components into barrels;
solidifying by dry ice cooling chemical components; and
obtaining by dry ice cooling the viscous chemical material.

5. The method as claimed in claim 1, wherein filtering means includes a coffee filter.

6. The method as claimed in claim 1, wherein filtering means includes a furnace filter.

7. A method of recycling process for municipal wastes and chemical wastes comprises,
providing by municipal wastes and chemical wastes chemical components;
handling of chemical components;
filtering by filtering means viscous chemical material;
obtaining by the filtering means filtered material;
distributing by distributing means the filtered material;
obtaining by distributing means usable energy;
reprocessing by energy reprocessing means the usable energy; and
obtaining by energy reprocessing means reprocessed energy products;

8. The method as claimed in claim 7 comprises,
providing non-chemical components;
decomposing by decomposition means the non-chemical components;
obtaining by decomposition means raw materials;
reprocessing by materials reprocessing means raw materials; and
obtaining by materials reprocessing means reprocessed manufactured goods;
sorting the non-chemical components;
fusing the non-chemical components; and
processing the non-chemical components.

9. The method as claimed in claim 7, wherein handling of chemical components, comprises,
storing chemical components into barrels;
solidifying by dry ice cooling chemical components; and
obtaining by dry ice cooling the viscous chemical material.

10. The method as claimed in claim 9, wherein filtering means includes a coffee filter.

11. The method as claimed in claim 9, wherein filtering means includes a furnace filter.

12. A method of recycling process for municipal wastes and chemical wastes comprises,
providing by municipal wastes and chemical wastes chemical components;
handling of chemical components;
filtering by filtering means viscous chemical material;
obtaining by the filtering means filtered material;
distributing by distributing means the filtered material;
obtaining by distributing means usable energy;
reprocessing by energy reprocessing means the usable energy;
obtaining by energy reprocessing means reprocessed energy products;
storing chemical components into barrels;
solidifying by dry ice cooling chemical components; and
obtaining by dry ice cooling the viscous chemical material.

13. The method as claimed in claim 12 comprises,
providing non-chemical components;
decomposing by decomposition means the non-chemical components;
obtaining by decomposition means raw materials;
reprocessing by materials reprocessing means raw materials; and
obtaining by materials reprocessing means reprocessed manufactured goods;
sorting the non-chemical components;
fusing the non-chemical components; and
processing the non-chemical components.

14. The method as claimed in claim 12, wherein filtering means includes a coffee filter.

15. The method as claimed in claim 12, wherein filtering means includes a furnace filter.
